(19) United States
(12) Patent Application Publication
(10) Pub. No.: US 2004/0101217 A1
(43) Pub. Date: May 27, 2004

(54) Hydrodynamic bearing, motor device, and method of plastic deformation processing

(76) Inventors: Shinji Kinoshita, Chiba-shi (JP); Hiromitsu Goto, Chiba-shi (JP); Kazuaki Oguchi, Chiba-shi (JP); Atsushi Ota, Chiba-shi (JP)

Correspondence Address: ADAMS & WILKS, 31st Floor, 50 Broadway, New York, NY, 10004, US

(21) Appl. No.: 10/674,150

(22) Filed: Sep. 29, 2003

(30) Foreign Application Priority Data
Sep. 30, 2002 (JP) 2002-284952

(51) Int. Cl. F16C 32/06

(52) U.S. Cl. 384/100

(57) ABSTRACT

A reliable hydrodynamic bearing having high rotational accuracy is offered. The hydrodynamic bearing for a small-sized motor is made of a special nonmagnetic steel material that is excellent in terms of machinability, wear resistance, and corrosion resistance. This special steel material contains 14.00% Cr, 8.00% Mn, 0.20% C, 2.00% Ni, 0.35% Si, and less than 0.05% P. This special steel material has high machinability and so machining accuracies such as surface roughness and squareness can be enhanced. Consequently, the rotational accuracy of the hydrodynamic bearing can be enhanced. This special steel material also has such a property that when pressure is applied to plastically deform it, the pressed surface hardens. Using this nature, the surfaces at which rotating and stationary parts of the bearing contact with each other are pressed. Thus, the surfaces are hardened. Hence, the wear resistance is improved.

### BACKGROUND OF THE INVENTION

1. Field of the Invention

The present invention relates to a hydrodynamic bearing, motor device, and so on and, more particularly, to be used to rotationally drive a magnetic storage medium, for example.

2. Description of the Related Art

In recent years, computers have improved in performance. With this trend, there is a demand for storage devices having larger capacities and operating at higher speeds. Various types have been put into practical use as such storage devices. Among these storage devices, hard disk drives in which a disk like storage medium is rotated at high speed by a spindle motor to read and write data on the medium have enjoyed wide use.

A hard disk drive reads and writes data at high speed with a head floating at a position several microns above a storage medium while rotating the storage medium at thousands of RPMs. Therefore, the spindle motor for rotating the storage medium is required to have high rotational accuracy. A bearing that supports a shaft by the spindle motor is an important element that determines the rotational accuracy of the spindle motor.

In the past, rolling bearings using ball bearings have been used as this kind of bearings. In recent years, hydrodynamic bearings which can produce higher rotational accuracies and have higher shock resistance have been used.

A hydrodynamic bearing supports a shaft by causing fluid such as oil to produce hydrodynamic pressure.

In order that a hydrodynamic bearing produce hydrodynamic pressure appropriately to support a shaft well, components need to have high machining accuracy. Therefore, bearing materials used in hydrodynamic bearings are required to have good machinability to achieve high machining accuracy.

Furthermore, modern hard disk drives have been generally used in such a way that the motor is rotated only when the need arises to read and write data, for reducing power consumption of computers. With this method of usage, the motor is rotated and stopped at greatly increased frequency.

In addition, the bearing repeatedly makes contacts due to rotations and stops. These contacts produce abrasive powder. The bearing gap of a hydrodynamic bearing is approximately 2 microns and so the abrasive powder may affect the bearing performance. For this reason, improvement of the wear resistance of the bearing material is also very important for the reliability of the final product. By enhancing the wear resistance, the repetition life of rotations and stops can be prolonged.

Furthermore, the hydrodynamic bearing is in contact with fluid such as oil and thus corrosion resistance is necessary. For example, if the bearing material contains a sulfur content, outgassing may occur from the bearing. The gases corrode the head of the hard disk drive. If lead is contained in the bearing material, the lead reacts with oil. Sometimes, the oil may gelate.

To satisfy these requirements, copper alloys are used as bearing materials. Also, various kinds of stainless steels are employed, or the part surface is processed in a given manner (such as nitriding). Alternatively, it is thermally processed.

The following is an invention using a material having excellent machinability:

Reference 1: JP-A-2002-13534

The invention described in Reference 1 uses a copper alloy in the bearing material as a bearing material having excellent machinability.

Furthermore, the following is an invention that has pursued good machinability of parts:

Reference 2: JP-A-2001-298899

In the invention described in Reference 2, the shaft of a spindle motor is made of free-cutting stainless steel.

In addition, the following is available as an invention that has made a spindle motor using a material having high machinability and wear resistance:

Reference 3: JP-A-2002-30386

In the invention described in Reference 3, the shaft of a spindle motor is made using a stainless steel which satisfies the above-described requirements and consists of given components. This shaft is supported to a stator by a ball bearing.

Copper alloys are superior in machinability to stainless steels but inferior in wear resistance. The results of experiments where rotation and stop are repeated indicate that their lives are shorter than stainless steel bearings.

Furthermore, even free-cutting stainless steels do not have sufficient wear resistance. Therefore, where free-cutting stainless steels are used, it is necessary to improve the wear resistance by nitriding the contact portions or by coating them with DLC (diamond-like carbon) after cutting processing. However, these surface treatments are quite expensive. Further, sulfur added to improve the free-cutting property presents the problem of outgassing.

Additionally, steel materials used in JP-A-2002-30386 have high machinability and wear resistance but where they are used in hydrodynamic bearings where a rotating member and a stationary member may contact with each other, the wear resistance is somewhat insufficient.

### SUMMARY OF THE INVENTION

Accordingly, it is an object of the present invention to provide a hydrodynamic bearing having high rotational accuracy and high reliability.

To achieve the above-described object, a first aspect of the present invention provides a hydrodynamic bearing having (a) a hollow member having a hollow portion provided with an opening portion at least one end thereof, (b) a rotating member including a rotating portion disposed inside the hollow portion so as to be rotatable relative to the hollow member and a shaft portion extending through the opening portion and arranged concentrically with the axis of rotation of the rotating portion, (c) fluid interposed between the hollow member and the rotating member, (d) hydrodynamic pressure-producing means acting on the fluid between the opposite surfaces of the hollow member and the rotating member to produce hydrodynamic pressure between the opposite surfaces described above, and (e) a seal portion formed on the inner surface side of the opening portion and acting to prevent leakage of the fluid. At least one of the rotating member and the hollow member is made of a stainless steel containing from 12 to 16% chromium and from 6 to 10% manganese. At least one of the opposite surfaces of the rotating member and the hollow member has underdone plastic deformation processing.

A second aspect of the invention is based on the hydrodynamic bearing of the first aspect described above and further characterized in that the constitutional components of the stainless steel satisfy at least one of the following requirements: (a) containing 2% carbon, (b) containing 2% nickel, (c) containing 0.15% sulfur, (d) containing 0.35% silicon, and (e) containing less than 0.05% phosphorus.

A third aspect of the invention is based on the hydrodynamic bearing of any one of the first and second aspects and further characterized in that hydrodynamic pressure-producing grooves are formed in at least one of the surface of the rotating member and the inner surface of the hollow portion and that the hydrodynamic pressure-producing means produces hydrodynamic pressure because the hydrodynamic pressure-producing grooves pump the fluid when the rotating member is rotating.

A fourth aspect of the invention is based on the hydrodynamic bearing of any one of the first through third aspects and further characterized in that the rotating portion is a disk member shaped like a disk and that the shaft portion is connected with the radial center of the disk member perpendicularly to the disk surface of the disk member.

A fifth aspect of the invention provides a motor comprising a hydrodynamic bearing of any one of the first through fourth aspects described above, a rotor connected with the shaft of the hydrodynamic bearing, a stator connected with the hollow member and supporting the hydrodynamic bearing and the rotor, and driving means for rotating the rotor.

A sixth aspect of the invention provides a method of plastic deformation processing of a hydrodynamic bearing having (a) a hollow member having a hollow portion provided with an opening portion at least one end thereof, (b) a rotating member including a rotating portion disposed inside the hollow portion so as to be rotatable relative to the hollow member and a shaft portion extending through the opening portion and arranged concentrically with the axis of rotation of the rotating portion, (c) fluid interposed between the hollow member and the rotating member, (d) hydrodynamic pressure-producing means acting on the fluid between the opposite surfaces of the hollow member and the rotating member to produce hydrodynamic pressure between the opposite surfaces described above, and (e) a seal portion formed on the inner surface side of the opening portion and acting to prevent leakage of the fluid. At least one of the rotating member and the hollow member is made of a stainless steel containing from 12 to 16% chromium and from 6 to 10% manganese. The method of plastic deformation processing consists of the step of pressing at least one of the opposite surfaces of the rotating member and the hollow member to thereby harden the pressed surface.

### BRIEF DESCRIPTION OF THE DRAWINGS

FIG. 1 is a cross-sectional view showing an axial cross section of a motor according to the present embodiment;

FIG. 2 is a graph showing the results of tests on CSS and NRRO of hydrodynamic bearings using a special steel material;

FIG. 3 is a constitutional table showing typical components of the special steel material;

FIG. 4 is a graph showing variations in hardness occurring when the special steel material is pressed;

FIG. 5 is a graph showing the machinability of the special steel material using a lathe;

FIG. 6 is a graph showing the drillability of the special steel material;

FIG. 7 is a graph showing the relation between the cold workability and hardness of the special steel material;

FIG. 8 shows the results of comparisons of corrosion resistance tests (salt spray tests);

FIG. 9 is a graph showing the results of comparisons of sliding wear resistance tests;

FIG. 10 is a table showing the results of environmental tests; and

FIG. 11 is a table showing the results of comparisons of corrosion resistance tests.

### DESCRIPTION OF THE PREFERRED EMBODIMENT

The preferred embodiment of the present invention is hereinafter described in detail.

(1) Summary of Embodiment

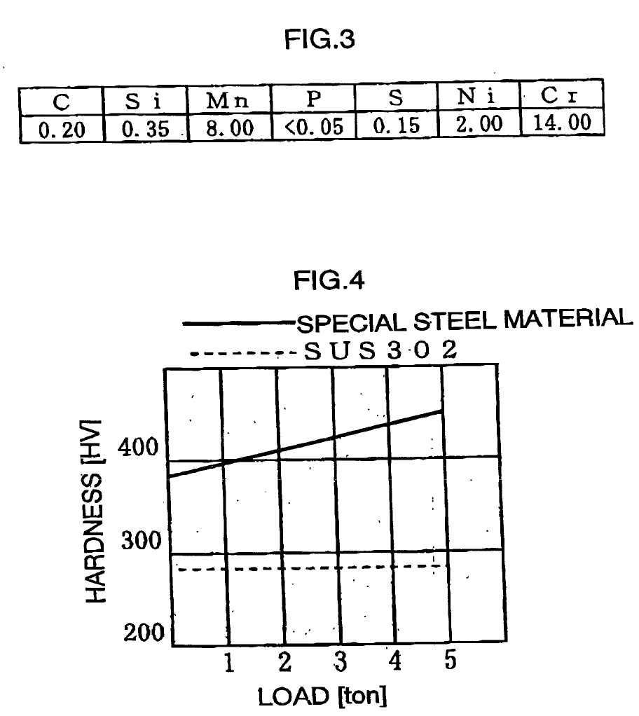

The hydrodynamic bearing of a small-sized motor used, for example, to drive a hard disk drive is made of a special steel material that is excellent in terms of machinability, wear resistance, and corrosion resistance and is nonmagnetic. Typical components of the special steel material are as shown in FIG. 3.

Since the special steel material has high machinability, machining accuracies such as surface roughness and squareness can be enhanced. Consequently, the rotational accuracy of the hydrodynamic bearing can be enhanced.

This special steel material has such a property that when pressure is applied to plastically deform the material, the surface to which the pressure is applied hardens, for the reason considered as follows. The composition makes a phase transformation from austenite to martensite.

Using this property, the wear resistance can be improved by pressing the surfaces of the rotating and stationary parts of the hydrodynamic bearing which contact with each other to harden them. In consequence, the reliability of the hydrodynamic bearing can be enhanced and its life can be prolonged.

Furthermore, if hydrodynamic pressure-producing grooves acting as hydrodynamic pressure-producing means in a hydrodynamic bearing are formed by stamping, then plastic deformation processing and formation of the hydrodynamic pressure-producing grooves can be simultaneously performed.

In addition, the special steel material contains no lead. Therefore, the related art surface treatment for preventing leakage of lead and improving the wear resistance of the surface can be dispensed with.

Further, it is excellent in terms of corrosion resistance and so generation of rust can be suppressed.

(2) Details of Embodiment

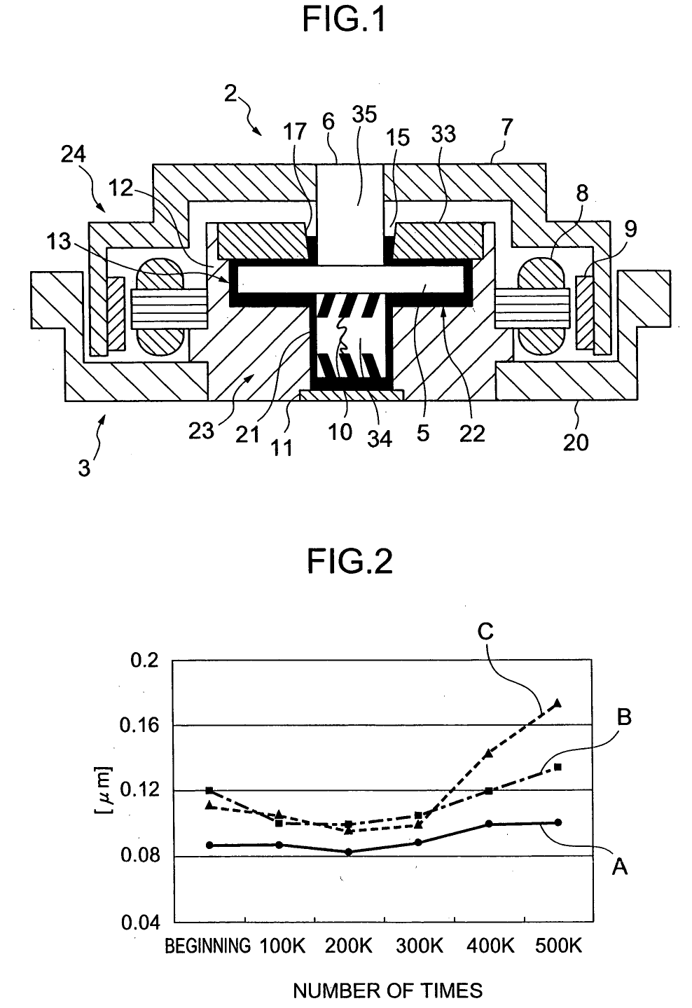

FIG. 1 is a cross-sectional view showing an axial cross section of a motor 1 according to the present embodiment.

The motor 1 has a rotor 2 (rotating member), a stator 3 supporting it, and a hydrodynamic bearing portion 23 for rotatably holding the rotor 2 to the stator 3 by hydrodynamic pressure of oil.

The hydrodynamic bearing portion 23 consists of a hollow portion, a shaft 6 received in this hollow portion, a rotating disk 5, and the oil (fluid) 13 filled in the gap portion of the hollow portion. The hollow portion is made up of a sleeve 12 and an end plate 11.

As shown in FIG. 1, the motor 1 is an inner rotor type motor device in which the rotor 2 is formed around the stator 3. An outer rotor type motor device is hereinafter described as an example. The invention is not limited to this. An inner rotor type motor can be constructed similarly.

The outer dimensions of the motor 1 are as follows. The thickness taken in the direction of axis of rotation is about 3.5 mm. The length taken in a radial direction is about 2 to 3 cm. The motor 1 is an ultraminiature hydrodynamic motor for use in a 1.8-inch hard disk drive, for example.

The motor 1 rotates at a high speed of 7200 rpm, for example. In addition, high positional accuracies are required. For instance, the amount of run-out in the radial direction (NRRO) must be less than 0.05 μm. The amount of run-out in the direction of axis of rotation must be less than 2 μm. Consequently, the hydrodynamic bearing structure that is a bearing structure adapted for this purpose is adopted.

Notice that no limitations are imposed on the size of the motor 1. A motor device of greater size or a smaller motor device may be constructed.

In addition, the application of the motor 1 is not limited to driving of a hard disk. For example, the motor may be used in applications where a small-sized, accurate motor device is necessary to rotate a polygon mirror in a laser printer, for example.

First, the rotor 2 is described.

The rotor 2 is made up of the shaft 6, a hub 7 disposed at the front-end portion (top-end portion as viewed in FIG. 1) of the shaft 6, a permanent magnet 9 fixedly mounted to the inner surface of the hub 7, and the rotating disk 5 formed at the other-end portion (lower-end portion as viewed in FIG. 1) of the shaft 6.

The hub 7 is a rotating disk on which a hard disk or the like is placed. The hub 7 assumes a convex disklike form having a step portion 24. A concave space for accommodating the hydrodynamic bearing portion 23 and coils 8 is formed in the convex inside.

A through hole in which the shaft 6 is inserted is formed in the center of the hub 7 as viewed in a radial direction, and this through hole extends in the direction of axis of rotation.

The hub 7 is fabricated by pressing or cutting stainless steel, for example.

A plurality of stages of hard disks can be installed on the outer surface of a cylindrical portion formed on the step portion 24. A head (not shown) is disposed on the surface of each of these hard disks such that the head can be moved radially by a servomechanism. Thus, data can be written and read to and from the hard disks.

The step portion 24 can be so constructed that it can be brought into agreement with a clamp-mounting hole formed in the center of a disk type storage medium such as a magnetooptical disk and placed in position. The removable storage medium can be driven.

The shaft 6 has a top-end portion that is mounted with a press fit in the through hole in the top-end portion of the hub 7. The hub 7 and shaft 6 can rotate as a unit.

The method of mounting together the hub 7 and shaft 6 is not limited to mounting with a press fit. They may also be mounted with screw mechanisms, with adhesive, or by welding.

The permanent magnet 9 is adhesively bonded to the inner surface of a cylinder formed inside the hub 7 concentrically with the shaft 6, the cylinder forming a concave shape. The permanent magnet 9 is made of a rare-earth magnet, for example.

The permanent magnet 9 is magnetized with a given number of poles in radial directions (in the direction toward the shaft 6 and directed outside from the shaft 6). N and S poles alternately appear circumferentially on the inner surface of the permanent magnet 9 at a regular interval.

Various numbers of poles can be used. In the present embodiment, the number of poles is 12. That is, 12 poles consisting of N and S poles are formed at a regular interval circumferentially on the inner surface of the permanent magnet 9.

The permanent magnet 9 is attracted by a rotating magnetic field produced by the coils 8, producing a torque to rotationally drive the rotor 2.

The shaft 6 is a substantially cylindrical rotating shaft disposed concentrically with the axis of rotation.

The shaft 6 is machined integrally with the rotating disk 5 and other-end portion 34 by scraping the shaft out of a stainless steel having a given composition (hereinafter referred to as the special steel material).

The special steel material is an austenitic stainless steel containing about 14.00% (hereinafter % means weight %) chromium (Cr) and about 8.00% manganese (Mn). This special steel material has excellent characteristics, i.e., high machinability, high wear resistance, high corrosion resistance, and suppressed outgassing.

The shaft 6 is made up of the rotating disk 5 formed like a disk over the whole periphery near the axial center of the shaft 6, a top-end portion 35 formed over the rotating disk 5 as viewed in FIG. 1, and the other-end portion 34 formed under the rotating disk 5.

The top-end portion 35 has a front-end portion inserted in a through hole formed in the hub 7.

Hydrodynamic pressure-producing grooves (not shown) such as herringbone grooves are formed in both end surfaces of the rotating disk 5 to produce hydrodynamic pressure in the thrust direction. These hydrodynamic pressure-producing grooves are formed by press working, etching, electric discharge machining, or other method.

The special steel material has such a property that when its surface undergoes plastic deformation processing by pressing the surface, the surface hardens. It is considered that the press work causes the surface metal structure to make a phase transformation from austenite to martensite.

Making use of this nature, the both surfaces of the rotating disk 5 have been hardened by pressing. This has improved the wear resistance.

In the present embodiment, the hydrodynamic pressure-producing grooves are formed by press working. Thus, formation of the hydrodynamic pressure-producing grooves and hardening of the surfaces are carried out simultaneously.

Furthermore, the hydrodynamic pressure-producing grooves may be formed by subjecting both end surfaces of the rotating disk 5 to plastic deformation processing to harden them and then performing etching or electric discharge machining.

Hydrodynamic pressure-producing grooves 10 (two stages of grooves like oblique lines tilted in different directions relative to the direction of axis) for producing radial hydrodynamic pressures are formed in the outer surface of the other-end portion 34 of the shaft 6. The hydrodynamic pressure-producing grooves 10 are formed by roll pressing or etching. The roll pressing hardens the outer surface of the other-end portion 34 and improves the wear resistance.

The rotor 2 forms a rotating member axially supported by the hydrodynamic bearing portion 23.

Next, the stator 3 is described.

The stator 3 includes the sleeve 12 accommodating the shaft 6 and so on, an upper plate 33 fitted over the top end of the sleeve 12 and forming a disk hollow portion 22 together with the sleeve 12, the coils 8 disposed on the outer surface of the sleeve 12, the end plate 11 forming the bottom portion of the sleeve 12, and a frame 20 disposed on the outer surface of the sleeve 12 and used to fix the motor 1 to a hard disk drive or the like. The sleeve 12 and upper plate 33 are made of the special steel material.

The sleeve 12 is a member constituting a stator-side portion of the hydrodynamic bearing portion. 23. The sleeve is fabricated by scraping it out of the special steel material.

The sleeve 12 is substantially cylindrical in shape. The disk hollow portion 22 for receiving the rotating disk 5 and an insertion hole 21 for receiving the other-end portion 34 are formed around a radial direction.

The lower end surface of the disk hollow portion 22 has been hardened by pressing it using an appropriate jig tool to perform plastic deformation.

A counterbore portion in which the upper plate 33 is mounted with a fit tolerance is formed at the upper end of the disk hollow portion 22. When the upper plate 33 is mounted in this counterbore portion, the disk hollow portion 22 that is analogous in shape to the rotating disk 5 is formed for the rotating disk 5.

The inside diameter of the insertion hole 21 is set greater than the outside diameter of the other-end portion 34 of the shaft 6. A given space to be filled with oil 13 is formed between the inner surface of the insertion hole 21 and the outer surface of the other-end portion 34.

A counterbore portion in which the end plate 11 is mounted with a fit tolerance is formed in the bottom portion of the insertion hole 21.

The end plate 11 is mounted in this counterbore portion. Consequently, an oil reservoir for storing the oil 13 is formed under the other-end portion 34.

The upper plate 33 is a member having a disklike form, and has a through hole in the radial center to permit insertion of the shaft 6. The upper plate 33 is made of the special steel material.

The inside diameter of the through hole increases at a given gradient in going toward the frond end of the shaft 6, thus forming a sleeve-side tapering portion 17.

The sleeve-side tapering portion 17 and the outer surface of the shaft 6 opposite to it together form a seal portion 15 for suppressing leakage of the oil 13.

Both end surfaces of the upper plate 33 have been hardened by pressing them to expose them to plastic deformation processing.

In the seal portion 15, the sleeve-side tapering portion 17 is opposite to the outer surface of the shaft 6 via a given gap. The dimension of this gap increases in going toward the front end of the shaft 6.

On the other hand, the oil 13 is filled almost up to the midpoint of the sleeve-side tapering portion 17 in the axial direction.

In the seal portion 15, a force due to capillarity that pulls the oil 13 toward the hydrodynamic bearing portion 23 and surface tension act on the surface of the oil 13. Because of these forces, a capillary seal that suppresses leakage of the oil 13 is formed in the seal portion 15.

The plural coils 8 are circumferentially equally spaced on the outer surface of the sleeve 12. In the present embodiment, nine coils 8 are arranged, and a stator coil of 9 poles is formed.

The magnetic poles of the coils 8 are formed radially outwardly and face the inner surface of the permanent magnet 9 with a given space therebetween.

Three-phase alternating current is supplied to the coils 8 from a power-supply system (not shown) to produce a rotating magnetic field circumferentially of the plural coils 8. This rotating magnetic field attracts the magnetic poles of the permanent magnet 9. A torque can be produced on the rotor 2.

The frame 20 is a flanged member, and its inner surface is fitted over the outer surface of the bottom portion of the sleeve 12.

A cylindrical member having a step portion swelling outward is formed at the upper end of the outer surface of the frame 20. The hub 7 is arranged concentrically on the inner surface side of the cylindrical member with a given space therebetween.

The frame 20 is held in a location where the motor 1 is installed, by mounting the step portion of the outer surface to a location where the enclosure of the hard disk drive or the like is installed.

The operation of the motor 1 constructed as described so far is next described.

When three-phase current is supplied to the coils 8 and the motor 1 is started, a rotating magnetic field is first produced on the outer surface side of the coils 8 arranged concentrically.

The magnetic poles formed on the inner surface of the permanent magnet 9 are attracted to this rotating magnetic field. A torque that rotates the rotor 2 around the axis of rotation is produced. This torque starts rotation of the rotor 2.

When the rotor 2 rotates, the hydrodynamic pressure-producing grooves 10 formed in the other-end portion 34 of the shaft 6 and in both end surfaces of the rotating disk 5 produce hydrodynamic pressure in the oil 13.

It is assumed that the rotor 2 rotates in a counterclockwise direction as viewed in the plane of FIG. 1. A pumping action owing to the hydrodynamic pressure-producing grooves 10 produces radial hydrodynamic pressure around the other-end portion 34, the radial hydrodynamic pressure being directed outward from the axis of rotation.

This is due to the pumping action of the hydrodynamic pressure-producing grooves 10. It is now assumed that the shaft 6 rotates the motor 1 in a counterclockwise direction as viewed from above in the direction of axis of rotation in FIG. 1. With respect to the upper hydrodynamic pressure-producing grooves 10, the oil 13 is pumped downward. With respect to the lower hydrodynamic pressure-producing grooves 10, the oil 13 is pumped upward.

As a result, the pressure of the oil 13 is increased between the upper and lower hydrodynamic pressure-producing grooves 10. Consequently, radial pressure is produced between the other-end portion 34 of the shaft 6 and the insertion hole 21.

The produced hydrodynamic pressure creates a radial pressure between the outer surface of the other-end portion 34 and the inner surface of the insertion hole 21 on the side of the stator 3, the inner surface being opposite to the outer surface of the other-end portion via the oil 13. The shaft 6 is supported in the radial direction by the balance between the pressures.

With respect to the rotating disk 5, if it rotates in a counter clockwise direction as viewed from above in the direction of axis of rotation in the figure, the pumping action owing to the hydrodynamic pressure-producing grooves 10 formed on the both end surfaces of the rotating disk 5 produces thrust hydrodynamic pressures on both end surfaces of the rotating disk 5.

The produced hydrodynamic pressures generate a thrust pressure between the both end surfaces of the rotating disk and the surfaces of the stator that are opposite to the both end surfaces of the disk 5 via the oil 13. The shaft 6 is supported in the thrust direction by the balance between the pressures produced on the both end surfaces.

In the present embodiment, the rotating disk 5, sleeve 12, and upper plate 33 have all undergone plastic deformation processing. The invention is not limited to this. It is also possible that only one of them undergoes plastic deformation processing.

The shape of the rotating disk 5 can take various forms. For example, its cross section can be a rhombus or trapezoid.

The rotor 2 is held so as to be rotatable about the axis of rotation by the balance between the radial pressure produced on the other-end portion 34 and the thrust pressure produced on the rotating disk 5 in this way.

Furthermore, in the present embodiment, the hydrodynamic pressure-producing grooves are formed in the rotor 2. The invention is not limited to this structure. The grooves may be formed on the side of the stator 3. Alternatively, the grooves may be formed in both rotor 2 and stator 3.

FIG. 2 shows measurements of the CSS (contact start stop) characteristics of a hydrodynamic bearing using a related art material (such as SUS300 series stainless steel) and of a hydrodynamic bearing using the special steel material. The CSS characteristics are graphs in which the number of repetitions of start and stop of a motor and resulting variations in NRRO (non-repeatable run-out) value are plotted.

NRRO is a numerical value indicating the degree of reproducibility of the rotor run-out. As this numerical value decreases, the reproducibility of the rotor run-out becomes higher. Error in reading and writing on the disk can be reduced.

The measurements were performed by installing a hard disk on the motor 1 and measuring the thrust run-out of the hard disk surface.

In the graph of FIG. 2, NRRO is plotted in micrometers (μm) on the vertical axis and the number of starts and stops divided by 1,000 on the horizontal axis.

Graph A gives the CSS characteristics of a hydrodynamic bearing made of the special steel material (hereinafter referred to as the hydrodynamic bearing of the special steel material). Graph B gives the CSS characteristics of a nitrided hydrodynamic bearing (hereinafter referred to as the related art hydrodynamic bearing) made of a SUS300 series stainless steel containing 2% Mn and 18% Cr. This is a typical related art hydrodynamic bearing.

Graph C is data for comparison and gives the CSS characteristics of a non-nitrided hydrodynamic bearing (hereinafter referred to as the compared hydrodynamic bearing) made of the same material as for graph B.

For these graphs, plural hydrodynamic bearings of the same composition were prepared and their average value was plotted.

For the hydrodynamic bearing of the new material, the initial value of NRRO was 0.09 μm. The initial values of the related art hydrodynamic bearing and compared hydrodynamic bearing were about 0.11 μm. The value of the new material is better by approximately 0.02 μm. Since the distance between the head of a hard disk drive and the disk surface is about tens of nanometers, this difference is very great for the hard disk drive.

The difference between the related art hydrodynamic bearing and the compared hydrodynamic bearing is presence or absence of nitriding processing. At initial values, the related art hydrodynamic bearing and compared hydrodynamic bearing are comparable in NRRO. In comparison, the NRRO of the bearing of the special steel material is better. It is estimated that the difference in NRRO is due to the difference in machining accuracy.

Furthermore, measurements of machined parts have shown that the special steel material is better than the related art material in machining accuracies such as squareness and surface roughness.

In addition, for the hydrodynamic bearing of the special steel material, the NRRO hardly varied after start and stop are repeated about 500 thousand times. The NRRO value obtained after the 500 thousand times repetition is smaller than the initial value of the related art hydrodynamic bearing. It is considered that this is due to the excellence of the wear resistance of the hydrodynamic bearing of the special steel material.

On the other hand, for the related art hydrodynamic bearing, as start and stop are repeated, the NRRO tends to increase slightly.

Furthermore, for the compared hydrodynamic bearing, the NRRO increases greatly as start and stop are repeated. This is considered that much wear occurs because no nitriding is performed.

FIG. 3 is a constitutional table showing typical components of the special steel material.

As can be seen from the constitutional table, the special steel material is an austenitic stainless steel containing 0.20% C (carbon), 0.35% Si (silicon), 8.00% Mn, from 0 to 0.005% P (phosphorus), 0.15% S (sulfur), from 0 to 2.00% Ni (nickel), and 14.00% Cr. The remaining percent is substantially Fe (iron). Note that % means weight % herein. The special steel material contains no Pb (lead).

The Mn content of the special steel material is preferably from 12% to 16%, more preferably from 13% to 15%, most preferably 14%.

Furthermore, the Cr content is preferably from 6% to 10%, more preferably from 7% to 9%, most preferably 8%.

In the composition described above, Si is added as a deoxidant. Si can be a cause of reduction of the corrosion resistance and so its content is approximately 0.35%.

Since Mn is an essential component for austenizing the steel composition, 8.00% Mn is added. This value is determined taking account of the C content. It is considered that Mn plays an important role in hardening the surface when the special steel material is pressed.

P reduces the frictional coefficients of steel materials. Since P acts as local cells, it deteriorates the corrosion resistance. Therefore, it is desired to minimize the amount of addition.

Although S has the advantage that it improves the machinability, it forms local cells within the steel material to thereby induce corrosion in the same way as P. Therefore, S is undesirable in terms of corrosion resistance. Furthermore, as the material is completed as a finished product, S causes outgassing of sulfide compounds from the material itself.

Accordingly, in the present embodiment, the S content is set to 0.15%.

Ni is added because it is a component holding the austenitic structure in the same way as Mn. The amount of addition is set less than 2.00%, for the following reasons. The advantages obtained by addition of Ni become conspicuous from around 1%. If N is contained in large amounts, the fabrication cost of the alloy increases greatly.

Cr is a component contributing to improvement of the corrosion resistance by forming a passivation film. Especially, Cr contributes to improvement of the salt resistance. Moreover, addition of Cr can improve the tensile strength of the steel material, elevate the yielding point, and increase the strength of the steel material. In addition, addition of Cr reduces deterioration due to welding, which in turn improves the weldability. However, it is necessary to determine the amount of addition within the range in which the fabrication cost is not increased much.

Additionally, in some cases, 0.20% N (nitrogen), from 0 to 0.10% Al (aluminum), from 0 to 3. BR>0% Mo (molybdenum), and from 0 to 3.0% Cu (copper) may be contained.

If Al is present as an Al oxide, the progress of rust will be accelerated. Therefore, the content is set to from 0 to 0.10%. Furthermore, the corrosion resistance is improved by letting Al exist as a carbide.

Mo is useful in elevating the yielding point of the tensile strength and improves corrosion resistances such as electrical corrosion resistance. Especially, it improves the characteristics against salt spray tests. However, if the Mo content is in excess of 5%, the fabrication cost as an alloy increases. In the present embodiment, therefore, the amount of addition is set to from 0 to 3%. Furthermore, for cold working, from 0 to 3.0% Cu may be contained.

The special steel material having the compositional ratio described above has corrosion resistance dispensing with plating and wear resistance dispensing with thermal treatment/soft nitriding. In the case of stainless steels used in the past, Pb is added frequently to improve the machinability. The special steel material according to the present embodiment has no Pb at all and, therefore, it corresponds as a Pb-free material. In addition, as described later, the surface roughness of the cut surface is better than that of the related art stainless steel.

These characteristics are achieved by adding trace amounts of C and S in a steel consisting principally of 8% Mn and 14% Cr in an attempt to stabilize the austenite and letting MnS distribute very finely and uniformly.

FIG. 4 is a graph showing variations in the hardness of the special steel material by pressing it. Rotating disks 5 made of the special material and SUS302 were used as test materials. After pressing the both end surfaces of each rotating disk 5 with a press machine, the hardness was measured with a Vickers hardness tester. The load applied by the press was up to 5 tons.

Experimental results have shown that with respect to the SUS303, even when load was applied, the hardness was kept at approximately Hv290 and did not vary. On the other hand, with respect to the special steel material, as load was applied, the surface hardness increased. Where no load was applied, the hardness was approximately Hv380. In contrast, where a load of 5 tons was applied, the hardness was about Hv430.

This is estimated as follows: The surface was subjected to plastic deformation processing by applying load, and this caused a phase transformation of the metal composition of the surface of the special steel material from austenite to martensite.

It seems that Mn within the special steel material contributes to this phase transformation. Furthermore, it seems that Ni also contributes to this phase transformation.

It has been confirmed from these experimental results that if load is applied to the special steel material, the hardness of the surface of the special steel increases. Therefore, using this, the surface hardness of the special steel material can be increased, and the wear resistance can be enhanced.

In the present experiments, the hardness of the surface of the special steel material was measured. It is considered that as the thickness of the special steel material decreases, the hardness within the material increases.

In view of the results given so far, in the present embodiment, a load of about 5 tons is applied to the rotating disk 5. Hydrodynamic pressure-producing grooves are pressed into both end surfaces of the rotating disk 5. Hardening of the surface and the formation of the hydrodynamic pressure-producing grooves are carried out at the same time.

It is also possible to harden the surfaces of the both end surfaces of the upper plate 33 and the bottom surface of the disk hollow portion 22 formed in the sleeve 12 by applying a load of about 5 tons to these surfaces.

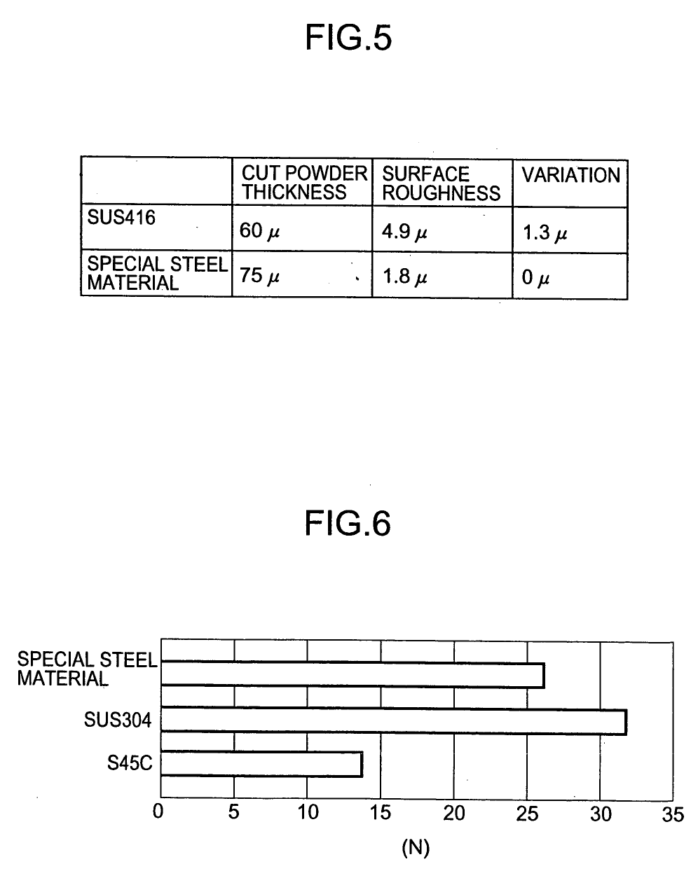

FIG. 5 is a diagram illustrating the machinability of the special steel material using a lathe.

The rotational frequency of the lathe in this comparative test is 2650 rpm, the peripheral speed is 50 m/min, and the amount of feed is 25 μm.

As shown in the table of FIG. 5, the special steel material produced better results than the SUS416 in terms of surface roughness and variations. Moreover, with respect to variations, 0 μm is achieved within the range of measurement error. With respect to the cutting powder thickness, the special steel material is somewhat greater, but the state is good. Production owing to nighttime unattended operation is possible.

FIG. 6 is a graph showing the drillability of the special steel material.

In this comparison test, the rotational speed of the drill is 50 rpm, the amount of feed is 0.07 mm/rev, the feed speed is 35 mm/min, and the feed depth is 10 mm. As shown in FIG. 6, the special steel material has a smaller resistance force [N] than that of SUS304 though is inferior to S45C. The drillability is good.

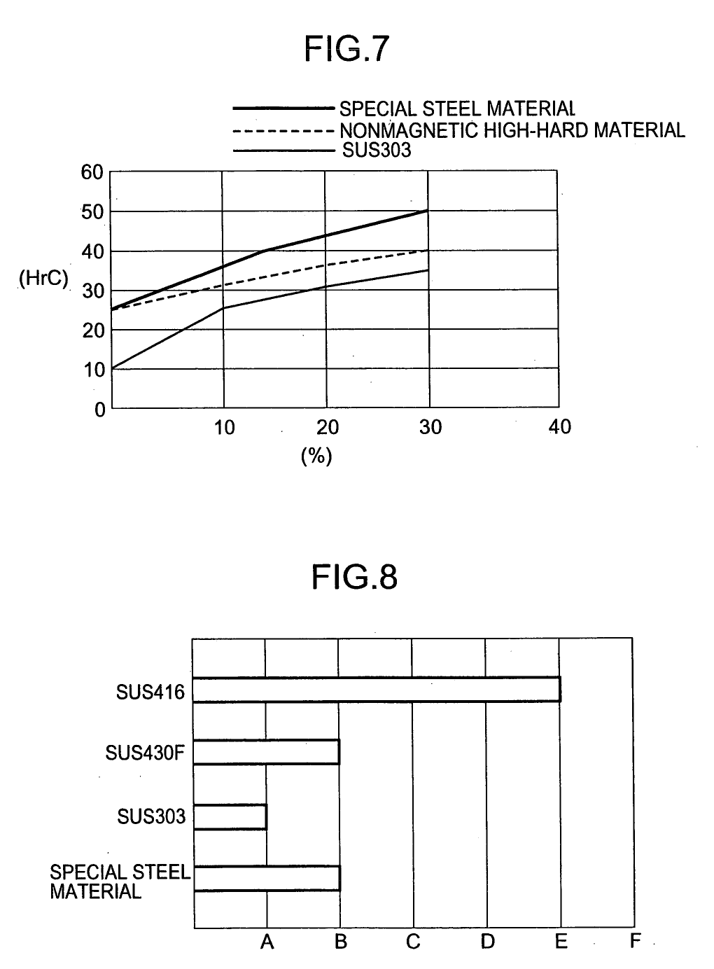

FIG. 7 is a diagram showing the relation between the cold workability of the special steel material and the hardness.

As shown, the hardness of the special steel material increases at the beginning as the cold workability increases. The hardness value reaches about HRC40 at a cold workability of 15%. Then, as the cold workability increases, the increase rate becomes milder. The hardness value reaches about HRC48 at a cold workability of 25%. Hardnesses exceeding those of nonmagnetic high-hard material (DSH400F) and SUS303 are obtained.

FIG. 8 shows the results of comparisons of corrosion resistance tests (salt spray tests). Degrees of rusting are ranked as follows. A: not corroded at all; B: little corroded; C: slightly corroded; D: corroded; E: considerably corroded. In this respect, the special steel material is inferior to SUS303 but has corrosion resistance (rank B) comparable to SUS430F.

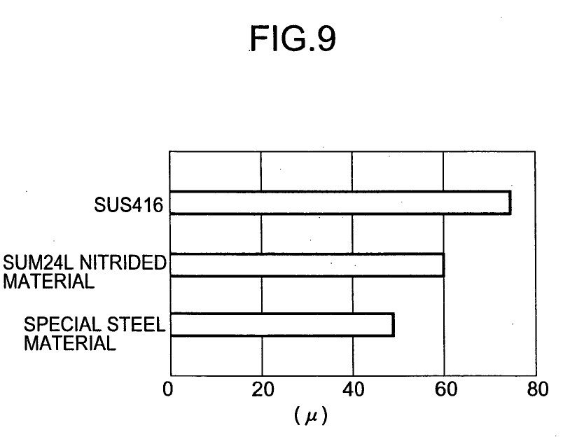

FIG. 9 is a diagram showing the results of comparisons of sliding wear tests.

As is obvious from the figure, the special steel material is smaller in abrasion wear than both SUM24L nitrided material and SUS416 and has high wear resistance characteristics.

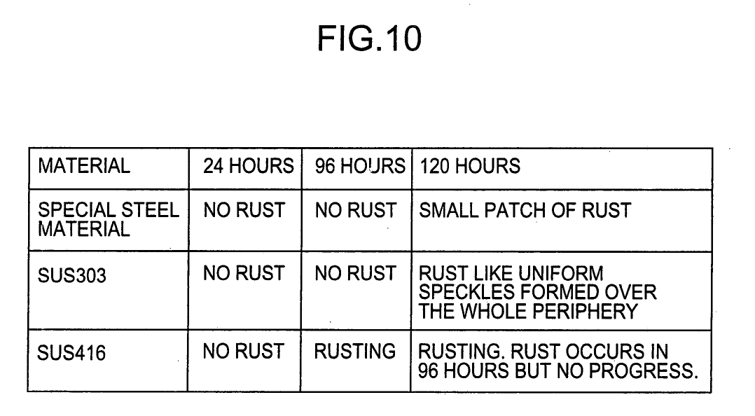

FIG. 10 is a table showing the results of an environmental test.

The conditions of the environmental test are 80° C. and a humidity of 95%. As shown in the table, rust occurred on the SUS416 in 96 hours. However, no progress occurred thereafter. However, magnified observation of a cut portion of the test piece has demonstrated that rust was produced on the cutting residue (pinholes that seem to be due to dropout of MnS during cutting).

On SUS303, rust consisting of speckles over the whole periphery was produced in 120 hours. With respect to the special steel material, a patch of rust occurred on the cut portion in 120 hours.

In the cut portions of the test pieces, dropout traces of sulfide (MnS) were confirmed on SUS303 and SUS416. On the other hand, no traces were found at all on the special steel material. It is considered that this is one cause of good results of the present environmental test.

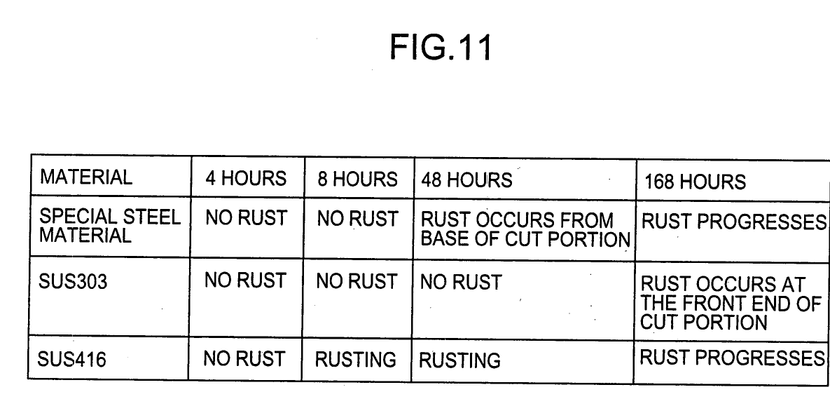

FIG. 11 is a table showing the results of comparisons of corrosion resistance tests.

The conditions of the corrosion resistance tests are 35° C. and 5% NaCl. On SUS416, rust occurred in 8 hours. Progress of rust with elapse of time can be confirmed on both cut portion and ground portion of the test piece. On SUS303, rust occurred at the cut front end portion of the test piece in 168 hours.

With respect to the special steel material, rust occurred at the base of the cut portion of the test piece in 48 hours. The rust spread onto the portion onto which salt water flowed down after 168 hours in a manner not shown in the table. Therefore, it can be seen that the special steel material does not have sufficient corrosion resistance in permeated state (such as in sea water) but assures sufficient corrosion resistance to be used in applications where the present embodiment is utilized such as electronic devices for personal computers and facsimile devices (such as OA devices).

The present embodiment described so far can yield the following advantages.

(1) The special steel material has good machinability. The surface roughness and squareness of the cut surface are improved. Therefore, NRRO and vibration resistance characteristics are improved by fabricating the hydrodynamic bearing portion 23 from the special steel material.

(2) The surfaces of the moving and stationary parts in the hydrodynamic bearing portion 23 which come into contact with each other are subjected to plastic deformation processing. Thus, the hardness of the surfaces of the parts is increased greatly. The wear resistance is improved.

(3) Since Pb is not contained, oil does not gelate. Furthermore, surface treatment for preventing gelation is unnecessary.

(4) Since the wear resistance is excellent, surface treatment is unnecessary.

(5) Since it is a nonmagnetic material, magnetized worn powder does not adhere to the hydrodynamic bearing portion 23 and so the reliability of the bearing improves.

While one embodiment of the present invention has been described so far, the invention is not limited to the described embodiment. Various changes can be made within the scopes set forth in the claims.

The present invention can offer hydrodynamic bearing, motor device, and so on which have high rotational accuracy and high reliability.

What is claimed is:

1. A hydrodynamic bearing comprising:
a hollow member having a hollow portion provided with an opening portion at least one end thereof;
a rotating member including a rotating portion disposed inside said hollow portion so as to be rotatable relative to said hollow member and a shaft portion extending-through said opening portion and arranged concentrically with an axis of rotation of said rotating portion;
fluid interposed between said hollow member and said rotating member;
hydrodynamic pressure-producing means acting on said fluid between opposite surfaces of said hollow member and said rotating member to produce hydrodynamic pressure between said opposite surfaces; and
a seal portion formed on an inner surface side of said opening portion and acting to prevent leakage of the fluid;
wherein at least one of said rotating member and said hollow member is made of a stainless steel containing from 12 to 16% chromium and from 6 to 10% manganese; and
wherein at least one of the opposite surfaces of said rotating member and said hollow member has underdone plastic deformation processing.

2. The hydrodynamic bearing of claim 1, wherein constitutional components of said stainless steel satisfy at least one of the following requirements: (a) containing 2% carbon, (b) containing 2% nickel, (c) containing 0.15% sulfur, (d) containing 0.35% silicon, and (e) containing less than 0.05% phosphorus.

3. The hydrodynamic bearing of claim 1, wherein hydrodynamic pressure-producing grooves are formed in at least one of a surface of said rotating member and an inner surface of said hollow portion, and wherein said hydrodynamic pressure-producing means produces hydrodynamic pressure because the hydrodynamic pressure-producing grooves pump the fluid when said rotating member is rotating.

4. The hydrodynamic bearing of claim 2, wherein hydrodynamic pressure-producing grooves are formed in at least one of a surface of said rotating member and an inner surface of said hollow portion, and wherein said hydrodynamic pressure-producing means produces hydrodynamic pressure because the hydrodynamic pressure-producing grooves pump the fluid when said rotating member is rotating.

5. The hydrodynamic bearing of claim 1, wherein said rotating portion is a disklike member shaped like a disk and that said shaft portion is connected with a radial center of the disklike member perpendicularly to a disk surface of the disk member.

6. The hydrodynamic bearing of claim 2, wherein said rotating portion is a disklike member shaped like a disk and that said shaft portion is connected with a radial center of the disklike member perpendicularly to a disk surface of the disk member.

7. The hydrodynamic bearing of claim 3, wherein said rotating portion is a disklike member shaped like a disk and that said shaft portion is connected with a radial center of the disklike member perpendicularly to a disk surface of the disk member.

8. A motor device comprising:
a hydrodynamic bearing of claim 1;
a rotor connected with the shaft of said hydrodynamic bearing;
a stator connected with said hollow member and supporting said hydrodynamic bearing and said rotor; and
driving means for rotating said rotor.

9. A motor device comprising:
a hydrodynamic bearing of claim 2;
a rotor connected with the shaft of said hydrodynamic bearing;
a stator connected with said hollow member and supporting said hydrodynamic bearing and said rotor; and
driving means for rotating said rotor.

10. A motor device comprising:
a hydrodynamic bearing of claim 3;
a rotor connected with the shaft of said hydrodynamic bearing;
a stator connected with said hollow member and supporting said hydrodynamic bearing and said rotor; and
driving means for rotating said rotor.

11. A motor device comprising:
a hydrodynamic bearing of claim 4;
a rotor connected with the shaft of said hydrodynamic bearing;
a stator connected with said hollow member and supporting said hydrodynamic bearing and said rotor; and
driving means for rotating said rotor.

12. A method of plastic deformation processing of a hydrodynamic bearing having
a hollow member having a hollow portion provided with an opening portion at least one end thereof,
a rotating member including a rotating portion disposed inside said hollow portion so as to be rotatable relative to said hollow member and a shaft portion extending through said opening portion and arranged concentrically with an axis of rotation of said rotating portion,
fluid interposed between said hollow member and said rotating member,
hydrodynamic pressure-producing means acting on said fluid between opposite surfaces of said hollow member and said rotating member to produce hydrodynamic pressure between said opposite surfaces, and
a seal portion formed on an inner surface side of said opening portion and acting to prevent leakage of the fluid,
at least one of said rotating member and said hollow member being made of a stainless steel containing from 12 to 16% chromium and from 6 to 10% manganese, said method of plastic deformation processing comprising the step of:
pressing at least one of the opposite surfaces of said rotating member and said hollow member to thereby harden the pressed surface.
